(19) United States
(12) Patent Application Publication
(10) Pub. No.: US 2026/0146879 A1
(43) Pub. Date: May 28, 2026

(54) METHOD FOR OPERATING A MAGNETIC-INDUCTIVE FLOWMETER

(71) Applicant: Endress+Hauser Flowtec AG, Reinach (CH)

(72) Inventors: Thomas Küng, Münchenstein (CH); Christian Knapp, Albbruck (DE); André Schaubhut, Schopfheim (DE)

(21) Appl. No.: 19/128,273

(22) PCT Filed: Sep. 18, 2023
(86) PCT No.: PCT/EP2023/075638

§ 371 Date: May 8, 2025

(30) Foreign Application Priority Data
Nov. 11, 2022 (DE) 10 2022 129 905.8

(51) Int. Cl. G01F 1/60; G01F 1/58

(52) U.S. Cl. CPC G01F 1/60; G01F 1/588

(57) ABSTRACT

Operating a magnetic-inductive flowmeter includes applying an operating signal having a first time segment having a first partial time segment where a signal value S_{+,I} is applied for a time duration t_{1,I}, and a second partial time segment where a signal value S_{-,I} is applied for a longer time duration t_{2,I}. Magnetic field polarities during time duration t_{1,I} and time duration t_{2,I} differ. The operating signal has a second time segment having a third partial time segment where a signal value S_{+,II} is applied for a time duration t_{1,II}, and a fourth partial time segment where a signal value S_{-,II} is applied for a longer time duration t_{2,I}. The method includes measuring a first measurement voltage during a segment of the first-time segment and a second measurement voltage during a segment of the second time segment, and determining the flow-rate-dependent measurement variable based on the first and second measurement voltage.

The invention relates to a method for operating a magnetic-inductive flowmeter, to a magnetic-inductive flowmeter and to a magnetic-inductive flow measurement probe.

Magnetic-inductive flowmeters are used for determining the flow rate and the volumetric flow of a flowing medium in a pipe. A distinction is made here between in-line magnetic-inductive flowmeters and magnetic-inductive flow measurement probes, which are inserted into a lateral opening of a pipe. A magnetic-inductive flowmeter has a magnetic-field-generating device for generating a magnetic field. A main axis of the magnetic field runs essentially perpendicular to the flow direction of the flowing medium. Saddle coils or solenoids are usually used for this purpose. In order to realize a predominantly homogeneous magnetic field, pole shoes are additionally formed and attached relative to the flow direction such that the magnetic field lines run over the entire tube cross-section essentially perpendicular to the transverse axis or in parallel with the vertical axis of the measuring tube. In addition, a magnetic-inductive flowmeter has a measuring tube for guiding the medium on the outer lateral face of which the magnetic-field-generating device is arranged. A pair of measurement electrodes attached to the lateral surface of the measuring tube taps a measurement voltage or potential difference which is perpendicular to the direction of flow and to the magnetic field and arises when a conductive medium flows in the direction of flow when the magnetic field is applied. Since, according to Faraday's law of induction, the tapped off measurement voltage depends on the velocity of the flowing medium, the flow rate and/or—with the inclusion of a known pipe cross-section—the volumetric flow can be determined from the measured induced measurement voltage.

In contrast to a magnetically-inductive flowmeter, which comprises a measuring tube for conducting the medium with an attached device for generating a magnetic field penetrating the measuring tube and which also comprises measuring electrodes, magnetically-inductive flow measurement probes are inserted with their usually circular cylindrical housings into a lateral opening of a pipe and fastened in a fluid-tight manner. A special measuring tube is no longer necessary. The measurement electrode arrangement and coil arrangement, mentioned at the outset, on the lateral surface of the measuring tube are omitted and are replaced by a device for producing a magnetic field, which device is arranged in the interior of the housing and in direct proximity to the measurement electrodes and is designed such that an axis of symmetry of the magnetic field lines of the produced magnetic field perpendicularly intersects the front face or the face between the measurement electrodes. In the prior art, there is already a plurality of different magnetically-inductive flow measurement probes.

Magnetically-inductive flowmeters are often used in process and automation engineering for fluids, starting from an electrical conductivity of approximately 5 μS/cm. Corresponding flow measurement devices are sold by the applicant in a wide variety of embodiments for various fields of application, for example under the names PROMAG or MAGPHANT.

WO 2020/001876 A1 discloses a method for operating a magnetic-inductive flowmeter in which, before the start of the measuring phase—in which the operating voltage alternates with a first frequency—there is a switch to a higher second frequency ±Uₛₕₒₜ. This causes the magnetic-field-generating device to heat up more quickly and therefore reduces the settling time that must be waited for until the magnetic field is stable. However, WO 2020/001876 A1 does not address how the zero point can be stabilized during the measurement phase.

A magnetic-inductive flowmeter is known from JP 2002-310751 A, which is operated with a two-frequency operating signal. This means that in the event that during the measuring phase the excitation current changes direction at a first frequency and at the same time at a second frequency which is higher than the first frequency alternates between a maximum excitation current and no excitation current. The advantage of such an operating signal is the stabilization of the zero point. The disadvantage is that time segments are provided in which no magnetic field is generated or a remanence field is present which typically amounts to only a few percent of the nominal magnetic field. This leads, on the one hand, to the fact that in these time segments no induced voltage at the measuring electrodes and thus no flow-rate-dependent process variable can be measured either and, on the other hand, the amplitude of the measuring signal is temporarily very low. This leads to increased measurement errors in applications with very high flow rate changes.

The object of the invention is to remedy this problem.

The object is achieved by the method according to claim 1, the magnetic-inductive flowmeter according to claim 14 and by the magnetic-inductive flow measurement probe according to claim 15.

The method according to the invention for operating a magnetic-inductive flowmeter for determining a flow-rate-dependent measurement variable of a flowable medium, which comprises a magnetic-field-generating device for generating a magnetic field and a device for detecting an induced measurement voltage in the medium, comprising the method steps of:
applying an operating signal to the magnetic-field-generating device in order to generate the magnetic field,
   wherein the operating signal has a first time segment,
   wherein the first time segment comprises at least a first partial time segment and a second partial time segment,
   wherein in the first partial time segment, a signal value S_{+,I} is applied in each case for a time duration t_{1,I},
   wherein in the second partial time segment, a signal value S_{-,I} is applied for a time duration t_{2,I},
   wherein the time duration ty is longer than the time duration t_{2,I}, wherein a magnetic field polarity during the time duration t_{1,I} differs from the magnetic field polarity during the time duration t_{2,I},
   wherein the operating signal has a second time segment which, in particular directly, follows the first time segment,
   wherein the second time segment comprises at least a third partial time segment and a fourth partial time segment,
   wherein in the third partial time segment, a signal value S_{+II} is applied for a time duration t_{1,II},
   wherein in the fourth partial time segment, a signal value S_{-II} is applied for a time duration t_{2,II},
   wherein the time duration t_{2,II} is longer than the time duration t_{1,II},
   wherein the magnetic field polarity during the time duration t_{1,II} differs from the magnetic field polarity during the time duration t_{2,II};
measuring a first measurement voltage value U_{I} of the induced measurement voltage during a measurement segment of the first time segment;
measuring a second measurement voltage value U_{II} of the induced measurement voltage during a measurement segment of the second time segment; and
determining a current zero point on the basis of the first measurement voltage value U_{II} and the second measurement voltage value U_{II} in order to compensate for the flow-rate-dependent measurement variable.

The operating signal can be a voltage signal that is applied to the magnetic-field-generating device. In this case, the voltage signal comprises a time-varying voltage which is generated by means of an operating circuit and is applied to the magnetic-field-generating device. The magnetic-field-generating device is designed in such a way that it generates a time-varying magnetic field on the basis of the applied operating signal. Typically, the magnetic-field-generating device comprises at least one coil which is in electrical connection with the operating circuit. Alternatively, the operating signal can also be a current signal which is set or specified at the magnetic-field-generating device. In this case, the operating circuit is configured to generate the current signal and provide it to the magnetic-field-generating device.

The operating signal is such that after the second time segment, the first time segment begins again, and after the first time segment, the second time segment once again follows. While the operating signal is being applied, at the device for detecting the induced measurement voltage, a measuring circuit measures the induced measurement voltage in the medium and the electrical potentials present at the individual measuring electrodes. The operating signal is therefore applied during the measurement phase. An evaluation circuit is designed to determine the flow-rate-dependent measurement variable on the basis of the measured measurement voltages or electrical potentials of different partial time intervals. The flow-rate-dependent measurement variable can be the flow rate, the volumetric flow, the mass flow and/or variables derived therefrom.

The current zero point can be determined as follows. In a first method step, a difference or an average value of two measurement voltages from preferably successive time intervals of opposite magnetic field polarity of the first time interval is determined. The first measurement voltage value U, results from the difference. This is used to determine the flow-rate-dependent measurement variable. In a second method step, the difference or the average value of two measurement voltages from preferably successive partial time intervals of the second time interval with opposite magnetic field polarity is also determined. The second measurement voltage value Un results from the difference. This is likewise used to determine the flow-rate-dependent measurement variable. The first measurement voltage value U, and the second measurement voltage value Un are input into the determination of the zero point effect. For example, the difference between the respective absolute values of the two determined measurement voltage values is determined, which itself has no flow-rate-dependent component and basically depends exclusively on the zero-point effect. The currently determined measured value of the flow-rate-dependent measurement variable is then corrected by the current zero point.

The advantage of the solution according to the invention is that time segments are avoided in which no current flows through the magnetic-field-generating device or no voltage is applied to the magnetic-field-generating device, and thus no magnetic field is generated. As a result, an induced voltage proportional to the flow rate of the medium can always be detected at the device for detecting the induced measurement voltage. It is precisely in applications in which the flow rate varies rapidly—such as in filling processes—that it is advantageous if the induced measurement voltage can be detected continuously over the entire measuring period.

Another advantage is that by applying the signal values S_{+,I}, S_{-,I}, S_{+,II} and S_{-,II}—which all differ from zero—a significantly higher signal amplitude can be achieved than in the method according to JP 2002-310751 A, and there is therefore less sensitivity to 1/f noise. Furthermore, the operating signal according to the invention results in a significant simplification of the control method since no segments are provided in which no current flows.

Advantageous embodiments of the invention are the subject-matter of the dependent claims.

One embodiment provides that during the first time segment, the first partial time interval, in particular the signal value S_{+,I} and the second partial time interval, in particular the signal value S_{-,I} at least temporarily alternate with a first frequency f_{1,I}.

One embodiment provides that during the second time segment, the third partial time interval, in particular the second signal value S., and the fourth partial time interval, in particular the second signal value S_{-,II} at least temporarily alternate with a second frequency f_{1,I}.

This not only means that the operating signal more than once assumes the signal value S_{-,I} and the signal value S_{-,I}, but also periodically. The same also applies to the repetitions of the signal value S_{+,II} and of the signal values S_{-,II}. The advantage of this is that a more stable flow-rate-dependent measurement variable can be determined from the measurement voltages measured during the repeating partial time intervals.

One embodiment provides that the first time segment and the second time segment alternate with a third frequency f₃.

One embodiment provides that the third frequency f₃ is lower than the first frequency f_{1,I} and the second frequency f_{2,II}.

One embodiment provides that a ratio of the third frequency f₃ and of the first frequency f_{1,I} and/or of the second frequency f_{2,II} lies between 2 and 1000, in particular 2 and 10 and One embodiment provides that a ratio of the time duration t_{1,I} and of the time duration t_{2,1} lies between 1 and 10, in particular 1.5 and 5 and preferably 2 and 3.

One embodiment provides that a ratio of the time duration t_{2,II} and of the time duration t_{1,II} lies between 1 and 10, in particular 1.5 and 5 and preferably 2 and 3.

One embodiment provides that the time duration t_{1,I} is equal to the time duration t_{2,II}, and/or the time duration t_{2,I} is equal to the time duration t_{1,II}.

Measured values of the coil current and of the coil voltage can also be used for controlling the operating signal. Accordingly, the time profile and/or measured values of the coil current and of the coil voltage during the longer time intervals can be determined and used for controlling the duration of the short time intervals and for determining the inductance of the magnetic-field-generating device. This means that the shorter time intervals can be selected to be shorter than in the case of operation with constant partial time intervals. This is particularly advantageous for suppressing 1/f interference signals. The inductance determined can be used for diagnosis, compensation and/or flux density control in order to ensure that the flow-rate-dependent measured values are correct and reliable even in the event of changes to the magnetic-field-generating device or under the influence of external disturbances.

One embodiment provides that the first time segment lasts for a time duration t_{3,I}.

One embodiment provides that a ratio of the time duration t_{3,I} and of the time duration t_{1,I} lies between 2 and 1000, in particular 3 and 10 and preferably 5 and 7.

One embodiment provides that a ratio of the duration t3,y and of the duration t_{2,I} lies between 4 and 2000, in particular 6 and 20 and preferably 10 and 14.

One embodiment provides that during the first partial time segment and/or the third partial time segment, a shot signal value S_{+,shot} for a time duration t_{+,shot} is applied, and/or wherein during the second partial time segment and/or the fourth partial time segment, a shot signal value S_{-,shot} for a time duration t_{-,shot} is applied.

The advantage of this embodiment is that the additional application of shot signal values in the individual time intervals results in a faster settling and thus stabilization of the generated magnetic field.

The magnetic-inductive flowmeter according to the invention for determining a flow-rate-dependent measurement variable of a flowable medium comprises:
a measuring tube for conducting the medium;
a device for detecting an induced measurement voltage in the medium
a magnetic-field-generating device arranged on the measuring tube for generating a magnetic field that penetrates the measuring tube; and
a measuring, operating and/or evaluation circuit which is designed to carry out the method according to the invention.

The magnetic-inductive flow measurement probe according to the invention for determining a flow-rate-dependent measurement variable of a flowable medium, comprising:
a housing with a front section to be acted upon by the medium,
a device for detecting an induced measurement voltage in a medium;
a magnetic-field-generating device arranged in the housing for generating a magnetic field penetrating the housing, in particular the front section; and
a measuring, operating and/or evaluation circuit which is designed to carry out the method according to the invention.

The invention is explained in greater detail with reference to the following figures. in which:

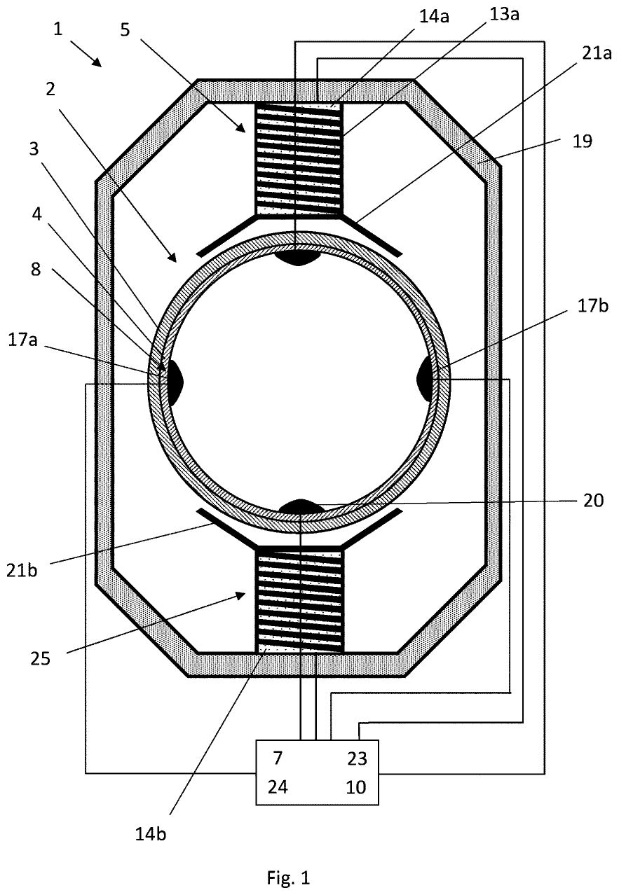

FIG. 1: shows an embodiment of a magnetic-inductive flowmeter;

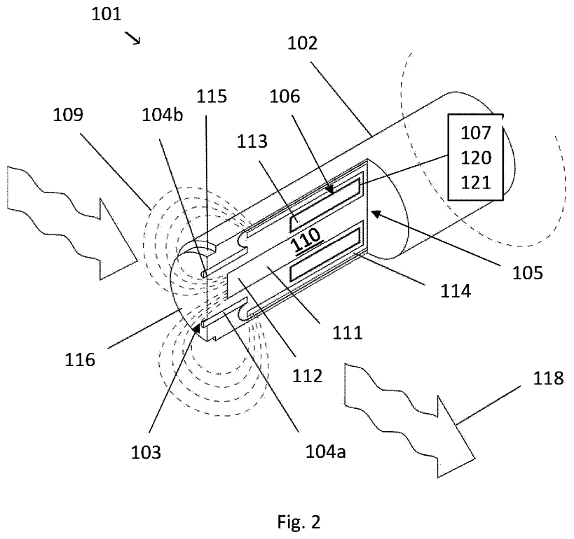

FIG. 2: shows a perspective view of a partially sectioned embodiment of a magnetic-inductive flow measuring probe;

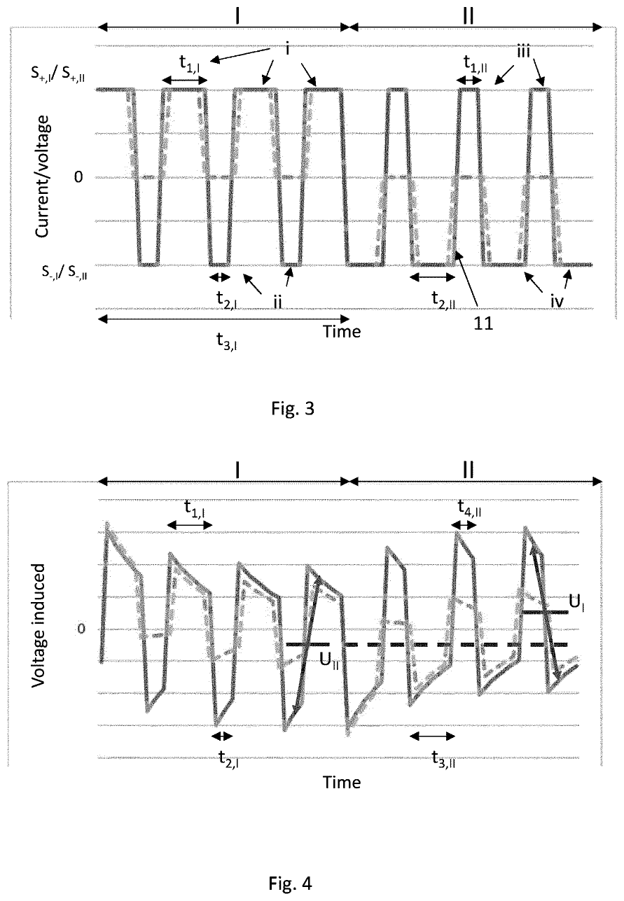

FIG. 3: shows a schematic representation of a first embodiment of the operating signal;

FIG. 4: shows a schematic representation of the measurement signal that would result from the operating signal of FIG. 3 at a flow rate of 0 m/s.

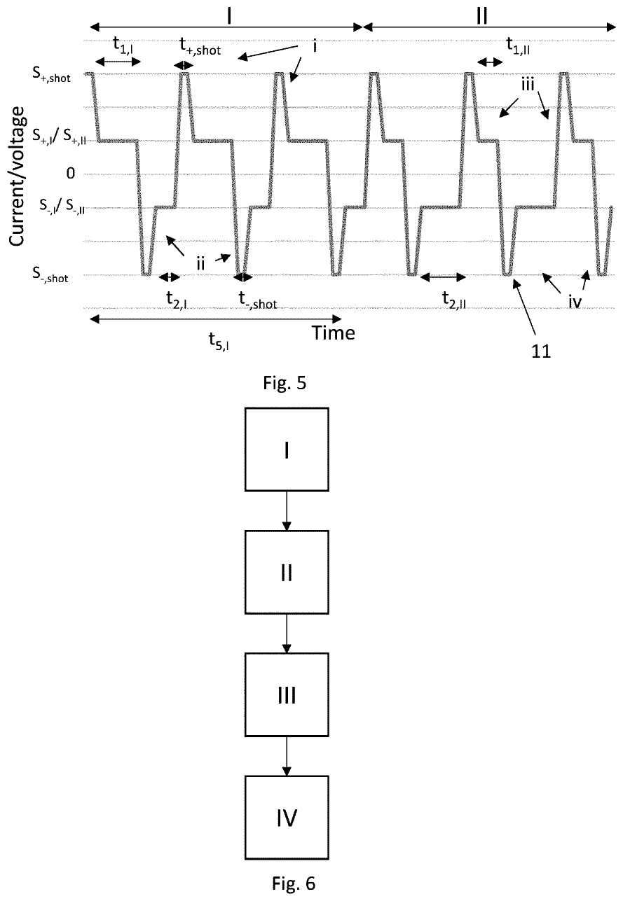

FIG. 5: shows a schematic representation of a second embodiment of the operating signal;

FIG. 6: shows an embodiment of the method according to the invention.

FIG. 1 shows a cross-section through a magnetic-inductive flow meter 1. The structure and measuring principle of a magnetic-inductive flowmeter 1 are known in principle. A flowable medium having an electrical conductivity is conducted through a measuring tube 2. The measuring tube 2 comprises a medium-contacting carrier tube 3, which is usually made of, or at least comprises, steel, ceramic, plastic or glass. A magnetic-field-generating device 5 for generating a magnetic field is arranged on the carrier tube 3 such that the magnetic field lines are oriented substantially perpendicularly to a longitudinal direction defined by a measuring tube axis. The magnetic-field-generating device 5 typically comprises a saddle coil or at least one solenoid 6i. A coil core 14i usually extends through a receptacle 15 of the coil 6i. The receptacle 15 is to be understood as the volume which is bounded by the coil wire that forms the coil 6i. The receptacle 15 of the coil 6i can thus be formed by a coil holder or by the imaginary enclosed volume. The latter occurs when the coil wire of the coil 6i is wound directly around the coil core 14i. The coil core 14i is formed from a magnetically conductive, in particular soft, magnetic material. The device 5 for generating the magnetic field comprises a pole shoe 21i which is arranged at one end of the coil core 14i. The pole shoe 21i can be a separate component or can be monolithically connected to the coil core 14i. In the embodiment shown in FIG. 1, two diametrically arranged coils 6a, 6b each have a coil core 14a, 14b and a pole shoe 21a, 21b. The two coil cores 14a, 14b are connected to one another via a field return 22. The field return 22 connects each of the sides of the coil cores 14a, 14b that face away from one another. However, magneto-inductive flowmeters with exactly one coil 6 having exactly one coil core 14 and without a field return are also known. The coil 6 is connected to an operating circuit 7 which operates the coil 6 by means of an operating signal. The operating signal can be a voltage with a time-variable curve and is characterized by operating signal parameters, wherein at least one of the operating signal parameters is controllable. The magnetic field generated by the device 5 for producing the magnetic field is produced by means of a pulsed direct current of alternating polarity provided by an operating circuit 7. This ensures a stable zero point and makes the measurement insensitive to influences due to electrochemical disturbances. The two coils 6a, 6b can be separately connected to the operating circuit 7 or connected in series or in parallel with one another.

When the magnetic field is applied, a flow-rate-dependent potential distribution results in the measuring tube 2, which can be detected, for example, in the form of an induced measurement voltage. A device 8 for tapping off the induced measurement voltage is arranged on the measuring tube 2. In the embodiment shown, the device 8 for tapping off the induced measurement voltage is formed by two oppositely arranged measurement electrodes 17, 18 in order to form a galvanic contact with the medium. However, it is known from magnetically-inductive flowmeters which comprise measurement electrodes arranged on the outer wall of the carrier tube 3 that are not in contact with the medium. The measurement electrodes 17, 18 are generally arranged diametrically and form an electrode axis, or are intersected by a transverse axis which runs perpendicular to the magnetic field lines and the longitudinal axis of the measuring tube 2. However, devices 8 intended for tapping off the induced measurement voltage and having more than two measurement electrodes are also known. The flow-rate-dependent measurement variable can be determined on the basis of the measured measurement voltage. The flow-rate-dependent measurement variable comprises the flow rate, the volumetric flow, and/or the mass flow of the medium. A measuring circuit 23 is configured to detect the induced measurement voltage applied to the measurement electrodes 17, 18, and an evaluation circuit 24 is designed to determine the flow-rate-dependent measured variable. The evaluation circuit 24 can be part of the transmitter.

The carrier tube 3 is often formed from an electrically conductive material such as steel. In order to prevent the measurement voltage applied to the first and second measurement electrodes 2, 3 from being conducted away via the carrier tube 3, the inner wall is lined with an insulating material, for example a liner 4 (made of plastic).

Commercially available magnetic-inductive flow meters have two further electrodes 19, 20 in addition to measurement electrodes 17, 18. In the first case, a fill level monitoring electrode 19 optimally attached at the highest point of the measuring tube 2 serves to detect partial filling of the measuring tube 1 and is configured to pass this information to the user and/or to take into account the fill level when determining the volumetric flow. In addition, a reference electrode 20, which is usually attached diametrically to the fill level monitoring electrode 19 or at the lowest point of the measuring tube cross-section, serves to set a controlled electrical potential in the medium. As a rule, the reference electrode 20 is used to connect the flowing medium to a ground potential.

The operating circuit 7, controller circuit 10, measuring circuit 23 and evaluation circuit 24 can be part of a single electronic circuit or can form individual circuits. The measuring, operating and/or evaluation circuit 7, 23, 24 is designed to carry out the method according to the invention. For this purpose, it can have a microprocessor and/or electrical components (electrical wiring, electromechanical components, passive and/or active components). For this purpose, the operating circuit is designed to generate the operating signal and provide it to the magnetic-field-generating device. Furthermore, the measuring circuit is designed to determine the measurement voltage values and forward them to the evaluation circuit. The evaluation circuit is designed to determine the current zero point and to take it into account for the determination of the flow-rate-dependent measurement variable.

First, the measuring principle on which the invention is based will be explained on the basis of the perspective and partially sectional illustration in FIG. 2. A flow measurement probe 101 comprises a generally circular cylindrical housing 102 having a predefined outer diameter. Said housing is adapted to the diameter of a hole, which is located in a wall of a tube line (not shown in FIG. 1) and into which the flow measurement probe 101 is inserted in a fluid-tight manner. A medium to be measured flows in the pipe, and the flow measuring probe 101 is immersed into said medium practically perpendicularly to the flow direction of the medium, which is indicated by the wavy arrows 118. A front end 116 of the housing 102 that projects into the medium is sealed in a fluid-tight manner with a front body 115 made of insulating material. By means of a coil arrangement 106 arranged in the housing 102, a magnetic field 109 that extends through the end portion into the medium can be produced. A coil core 111, which at least partially consists of a soft magnetic material and is arranged in the housing 102, terminates at or near the end portion 116. A field return body 114 that surrounds the coil arrangement 106 and the coil core 111 is configured to return, into the housing 102, the magnetic field 109 extending through from the end portion. The coil core 111, the pole shoe 112 and the field return body 114 are each field-conducting bodies 110, which together form a field-conducting arrangement 105. A first and a second measurement electrode 104i forming a galvanic contact with the medium to be conducted form the device 103 for detecting a measurement voltage induced in the medium and are arranged in the front body 115 and, like the outer walls of the housing, touch the medium. A voltage induced due to Faraday's law of induction can be tapped off at the measuring electrodes 104i by means of a measurement and/or evaluation circuit. It is at a maximum when the flow measurement probe 101 is installed in the pipe such that a plane spanned by a straight line intersecting the two measurement electrodes 104i and by a longitudinal axis of the flow measurement probe runs perpendicular to the flow direction 118 or to the longitudinal axis of the pipe. An operating circuit 107 is electrically connected to the coil arrangement 106, in particular to the coil 113, and is configured to apply a clocked operating signal onto the coil 113 in order to thus generate a clocked magnetic field 109.

The measuring, operating and/or evaluation circuit 107, 120, 121 is suitable and configured to carry out the method according to the invention. For this purpose, it can have a microprocessor and/or electrical components (electrical wiring, electromechanical components, passive and/or active components). For this purpose, the operating circuit is designed to generate the operating signal and provide it to the magnetic-field-generating device. Furthermore, the measuring circuit is designed to determine the measurement voltage values and forward them to the evaluation circuit. The evaluation circuit is designed to determine the current zero point and to take it into account for the determination of the flow-rate-dependent measurement variable.

FIG. 3 shows a simplified schematic representation of a first embodiment of the operating signal (solid line) and an operating signal according to the prior art (dashed line). The operating signal can be a voltage signal or a current signal. In the event that the operating signal is a voltage signal, this comprises time-varying voltage values that are applied to the magnetic-field-generating device. In the event that the operating signal is a current signal, this includes time-varying current values that are set at the magnetic-field-generating device. The depicted graph shows the current or the voltage as a function of time. According to the prior art, the operating signal changes periodically between two time intervals. In the first time interval, the operating signal alternates between the signal value S_{+,I} and a signal value of zero. The first partial time interval has four partial time intervals in which the operating signal assumes the signal value S_{+,I} and three partial time intervals in which the operating signal is zero. In the second time interval, the generated magnetic field changes the magnetic field polarity. In the second time interval, the operating signal alternates between the signal value S_, and a signal value of zero. The second partial time interval has four partial time intervals in which the operating signal has the signal value S_{+,I} and three partial time intervals in which the operating signal is zero. The respective time duration in which the signal value S_{+,I} or S_{-,II} is applied is identical to the time duration in which the operating signal assumes a signal value of zero. The operating signal shown is called a dual-frequency operating signal.

The operating signal according to the invention differs from the prior art basically in that there are no partial time intervals in which the operating signal assumes a signal value of zero. Furthermore, the time durations t_{1,I} and t_{2,I} or t_{1,I} and t_{2,II} of the time intervals i, ii, iii, iv in which the signal values S_{+,I} and S_{-,I} or S_{+,II} and S_{-,II} are applied differ. In the embodiment shown, the time durations t_{1,I} and t_{2,1} assume a ratio of 1:2, and the time durations t_{1,II} and t_{2,II} assume a ratio of 2:1. The ratio changes at a change from the first time interval to the second time interval or from the second time interval to the first time interval. The first time interval lasts for a time duration t_{3,I}. In the embodiment shown, the duration of the first time interval is identical to the duration of the second time interval. Also identical are the signal values S_{+,I} and S_{+,II} and the signal values S_{-,I} and S_{-,II} or the absolute values of the four signal values S_{+,I}, S_{+,II}, S_{-,I} and S_{-,II}. The time duration t_{1,I} is identical to the time duration t_{2,II}and the time duration t_{2,I} is identical to the time duration t_{1,II}. Alternatively, a ratio of the time duration t_{1,I} and the duration t_{2,I} can lie between 1 and 10, in particular 1.5 and 5 and preferably 2 and 3. Alternatively, a ratio of the time duration t_{2,II} and the time duration t_{1,II} can lie between 1 and 10, in particular 1.5 and 5 and preferably 2 and 3. For the optimal configuration of the operating signal, a ratio of the time duration t_{3,I} and the time duration t_{1,I} can be set between 2 and 1000, in particular 3 and 10 and preferably 5 and 7, and a ratio of the time duration t_{3,I} and the time duration t_{2,I} can be set between 4 and 2000, in particular 6 and 20 and preferably 10 and 14.

FIG. 4 shows schematic representations of the measurement signal which would result from the operating signal according to the invention in FIG. 3 and the operating signal according to the prior art at a flow rate of 0 m/s. The measuring signal comprises the measurement voltage induced by the flowing medium (in this case the measurement voltage is zero) with a simplified interference signal, which provides an exponentially decaying portion. The interference signal is caused by crosstalk from the magnetic-field-generating device to the device for detecting the induced measurement voltage. Typically, the measurement voltage, viewed over time, is measured in the later part of a time interval of constant magnetic field polarity since the influence of the interference is minimal there. Operating the magnetic-field-generating device at a higher frequency results in a larger zero point (see U, and Un) because an interference induced when switching the coil current direction can decay to a lesser extent before the next switching occurs. This interference cannot be reliably distinguished from an actual flow. For example, the average value of two measurement voltages with two consecutive time intervals with opposite magnetic field polarity (red double arrows) and without a respective flow-dependent signal component is not dependent on the zero point effect either.

In the light of the measurement signal (dashed line) resulting from the operating signal 11 according to the prior art, the advantage of the operating signal according to the invention is clearly evident.

The measurement signal resulting from the operating signal according to the invention has a significantly higher amplitude of the measurement signal for all partial time intervals. It is precisely at the beginning of the switching process that the amplitude in the conventional solution is very low and close to 0 V. Only after several partial time intervals does the amplitude increase for the partial time intervals in which no coil current flows through the magnetic-field-generating device until it basically reaches half of the maximum amplitude.

FIG. 5 shows a schematic representation of a second embodiment of the operating signal 11. The second embodiment of the operating signal 11 differs from the first embodiment basically in that during the first partial time segment i and the third partial time segment iii, a shot signal value S_{+,shot} (e.g. a shot voltage) is additionally applied for a time duration t_{+,shot}, and that during the second partial time segment ii and the fourth partial time segment iv, a shot signal value S_{-,shot} (e.g. a shot voltage) is additionally applied for a time duration t_{-,shot}. The absolute value of the individual shot signal values and the time durations are identical in the case of the embodiment shown. The absolute values of the individual shot signal values and also the time durations in which the corresponding shot signal value is applied can differ from one another.

FIG. 6 shows an embodiment of the method according to the invention. An operating signal is applied to the magnetic-field-generating device for generating the magnetic field (method step I). The operating signal has a first time segment with at least a first partial time segment and a second partial time segment. In the first partial time segment, a signal value is applied in each case for a time duration t_{1,I}, and in the second partial time segment, a signal value S_{-,I} is applied for a time duration t_{2,II}. During the time duration t_{1,I} a magnetic field polarity of the generated magnetic field differs from the magnetic field polarity during the time duration t_{2,I}. According to the invention, the time duration t_{1,I} is longer than the time duration t_{2,I}. Accordingly, in the first time duration, the time portion in which the signal value S_{+,I} is applied is longer than the time portion in which the signal value S_{-,I} is applied.

The operating signal further comprises a second time segment which directly follows the first time segment. However, a further time segment in which the signal value is zero can be provided between the first time duration and the second time duration. The second time segment has at least a third partial time segment in which a signal value S_{+,II} for a time duration tin is applied and a fourth partial time segment in which a signal value S_{-,II} for a time duration t_{1,II} is applied. The magnetic field polarity during the time duration t_{1,II} differs from the magnetic field polarity during the time duration t_{2,II}. According to the invention, the time duration t_{2,II} is longer than the time duration t_{1,II} . Accordingly, in the second time segment, the time portion in which the signal value S_{-,II} is applied is longer than the time portion in which the signal value S_{+,II} is applied.

It is essential to the invention that during the first time duration, the signal value S_{+,I} and the signal value S_{-,I} at least temporarily alternate with a first frequency f_{1,I}, and that during the second time duration, the second signal value S_{+,II} and the second signal value S_{-,II} at least temporarily alternate with a second frequency f_{2,II}. At the same time, the first time segment and the second time segment alternate with a third frequency f₃ which is lower than the first frequency f_{1,I} and the second frequency f_{2,II}. Accordingly, the operating signal according to the invention is also a two-frequency operating signal.

While the operating signal is being applied, a first measurement voltage value U_{I} of the induced measurement voltage is measured during a measurement segment of the first time segment (I) (method step II).

Offset in time in relation to the first time segment (I) during a measurement segment of the second time segment (II), a second measurement voltage value U_{II} of the induced measurement voltage is measured (method step III).

From the measured first measurement voltage value U_{I} and second measurement voltage value UIT, a current zero point is determined for compensating for the flow-rate-dependent measurement variable (method step IV). This can be realized by forming a difference between the two measured voltage values U_{I} and U_{II}. The flow-rate-dependent measurement variable is determined on the basis of the measurement voltage values of different partial time intervals of a time interval and compensated for by the current zero point.

Method steps I to IV are not to be interpreted as sequential method steps. For example, the induced measurement voltage is measured during the application of the operating signal in method step I.

### LIST OF REFERENCE SIGNS

Magnetically-inductive flowmeter 1
Measuring tube 2
Carrier tube 3
Liner 4
Magnetic-field-generating device 5
Operating circuit 7
Device 8 for detecting the induced measurement voltage
Controller circuit 10
Operating signal 11
Coil 13i
Coil core 14i
Measuring electrode 17i
Field return body 19
Pole shoe 21i
Measuring circuit 23
Evaluation circuit 24
Magnetic-inductive flow measurement probe 101
Housing 102
Device 103 for measuring an induced measurement voltage
Measuring electrode 104i
Magnetic-field-generating device 105
Coil arrangement 106
Operating circuit 107
Magnetic field 109
Field-conducting body 110
Coil core 111
Pole shoe 112
Coil 113
Field return body 114
Front body 115
End section 116
Direction of flow of the medium 118
Measuring circuit 120
Evaluation circuit 121

1-15. (canceled)

16. A method for operating a magnetic-inductive flowmeter for determining a flow-rate-dependent measurement variable of a flowable medium, which comprises a magnetic-field-generating device for generating a magnetic field and a device for detecting an induced measurement voltage in the medium, comprising the method steps of:
applying an operating signal to the magnetic-field-generating device for generating the magnetic field,
wherein the operating signal has a first time segment,
wherein the first time segment comprises at least a first partial time segment and a second partial time segment,
wherein in the first partial time segment, a signal value S_{-,I} is applied in each case for a time duration t_{1,I},
wherein in the second partial time segment, a signal value S_{-,I} is applied for a time duration t_{2,I},
wherein the time duration t_{1,I} is longer than the time duration t_{2,I},
where a magnetic field polarity during the time duration t_{1,I} differs from the magnetic field polarity during the time duration t_{2,I},
wherein the operating signal has a second time segment which follows the first time segment,
wherein the second time segment comprises at least a third partial time segment and a fourth partial time segment,
wherein in the third partial time segment, a signal value S_{+,II} is applied for a time duration t_{1,II},
wherein in the fourth partial time segment, a signal value S_{-,I} is applied for a time duration t_{2,II},
wherein the time duration t_{2,II} is longer than the time duration t_{1,II},
where the magnetic field polarity during the time duration t_{1,II} differs from the magnetic field polarity during the time duration t_{2,II},
measuring a first measurement voltage value U_{I} of the induced measurement voltage during a measurement segment of the first time segment;
measuring a second measurement voltage value U_{II} of the induced measurement voltage during a measurement segment of the second time segment; and
determining a current zero point based on the basis of the first measured voltage value U_{I} and of the second measurement voltage value Un in order to compensate for the flow-rate-dependent measurement variable.

17. The method of claim 16,
wherein during the first time segment, the signal value S_{+,I} and the signal value S_{-,I} least temporarily alternate with a first frequency.

18. The method of claim 17,
wherein during the second time segment the second signal value S_{+,II} and the second signal value S_{-,II} at least temporarily alternate with a second frequency.

19. The method of claim 16,
wherein the first time segment and the second time segment alternate with a third frequency.

20. The method of claim 19,
wherein the third frequency is lower than the first frequency and the second frequency.

21. The method of claim 19,
wherein a ratio of the third frequency and the first frequency and/or the second frequency lie between 2 and 1000.

22. The method of claim 16,
wherein a ratio of the time duration t_{1,I} and the time duration t_{2,I} lies between 1 and 10.

23. The method of claim 16,
wherein a ratio of the time duration t_{2,II} and the time duration t_{1,II} lies between 1 and 10.

24. The method of claim 16,
wherein the time duration t_{1,I}is equal to the time duration t_{2,II}, and/or the time duration t_{2,I} is equal to the time duration t_{1,II}.

25. The method of claim 16,
wherein the first time segment lasts for a time duration t_{3,I}.

26. The method according to claim 25,
wherein a ratio of the time duration t_{3,I}and the time duration t_{1,I} lies between 2 and 1000.

27. The method according to claim 25,
wherein a ratio of the time duration t_{3,I} and the time duration t_{2,I} lies between 4 and 2000.

28. The method according to claim 16,
wherein during the first partial time segment and/or the third partial time segment, a shot signal value S_{+,shot} is applied for a time duration t_{+,shot}, and/or
wherein during the second partial time segment and/or the fourth partial time segment, a shot signal value S_{-,shot} is applied for a time duration t_{-,shot}.

29. A magnetic-inductive flowmeter for determining a flow-velocity-dependent measurement variable of a flowable medium, comprising:
a measuring tube for conducting the medium;
a device for detecting an induced voltage in the medium
a magnetic-field-generating device arranged on the measuring tube for generating a magnetic field that penetrates the measuring tube; and
a measuring, operating, and/or evaluation circuit which is designed to carry out the following method:
applying an operating signal to the magnetic-field-generating device for generating the magnetic field,
wherein the operating signal has a first time segment,
wherein the first time segment comprises at least a first partial time segment and a second partial time segment,
wherein in the first partial time segment, a signal value S_{+,I} is applied in each case for a time duration t_{1,I},
wherein in the second partial time segment, a signal value S_{-,I} is applied for a time duration t2,1,
wherein the time duration t_{1,I} is longer than the time duration t_{2,I},
where a magnetic field polarity during the time duration t_{1,I} differs from the magnetic field polarity during the time duration t_{2,I},
wherein the operating signal has a second time segment which follows the first time segment,
wherein the second time segment comprises at least a third partial time segment and a fourth partial time segment,
wherein in the third partial time segment, a signal value S_{+,I} is applied for a time duration t_{1,II},
wherein in the fourth partial time segment, a signal value S_{+,II} is applied for a time duration t_{2,II},
wherein the time duration t_{2,II} is longer than the time duration t_{1,II},
where the magnetic field polarity during the time duration t_{1,II} differs from the magnetic field polarity during the time duration t_{2,II};
measuring a first measurement voltage value U_{I} of the induced measurement voltage during a measurement segment of the first time segment;
measuring a second measurement voltage value U_{II} of the induced measurement voltage during a measurement segment of the second time segment; and
determining a current zero point based on the basis of the first measured voltage value U_{I} and of the second measurement voltage value U_{II} in order to compensate for the flow-rate-dependent measurement variable.

30. The magnetic-inductive flowmeter for determining a flow-velocity-dependent measurement variable of a flowable medium, comprising:
a housing with a front section to be acted upon by the medium,
a device for detecting an induced voltage in a medium;
a magnetic-field-generating device arranged in the housing for generating a magnetic field penetrating the housing, in particular the front section; and
a measuring, operating and/or evaluation circuit which is designed to carry out the method according to the following method:
applying an operating signal to the magnetic-field-generating device for generating the magnetic field,
wherein the operating signal has a first time segment,
wherein the first time segment comprises at least a first partial time segment and a second partial time segment,
wherein in the first partial time segment, a signal value S_{+,I} is applied in each case for a time duration t_{1,I},
wherein in the second partial time segment, a signal value S_{-,I} is applied for a time duration t_{2,I},
wherein the time duration t_{1,I} is longer than the time duration t_{2,I},
where a magnetic field polarity during the time duration t_{1,I} differs from the magnetic field polarity during the time duration t_{2,I},
wherein the operating signal has a second time segment which follows the first time segment,
wherein the second time segment comprises at least a third partial time segment and a fourth partial time segment,
wherein in the third partial time segment, a signal value S_{+,II} is applied for a time duration t_{1,II},
wherein in the fourth partial time segment, a signal value S_{-,II} is applied for a time duration t_{2,II},
wherein the time duration t_{2,II} is longer than the time duration t_{1,II},
where the magnetic field polarity during the time duration t_{1,II} differs from the magnetic field polarity during the time duration t_{2,II};
measuring a first measurement voltage value U_{I} of the induced measurement voltage during a measurement segment of the first time segment;
measuring a second measurement voltage value U_{II} of the induced measurement voltage during a measurement segment of the second time segment; and
determining a current zero point based on the basis of the first measured voltage value U_{I} and of the second measurement voltage value U_{II} in order to compensate for the flow-rate-dependent measurement variable.
